(19) United States
(12) Patent Application Publication
(10) Pub. No.: US 2010/0031033 A1
(43) Pub. Date: Feb. 4, 2010

(54) APPARATUS AND METHOD OF SHARING DRM AGENTS

(75) Inventors: Hyoung-Shick KIM, Suwon-si (KR); Sang-Hyeon Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/965,074

(22) Filed: Dec. 27, 2007

(30) Foreign Application Priority Data
Aug. 6, 2007 (KR) 10-2007-0078634

(51) Int. Cl. H04L 9/32; H04L 9/00

(52) U.S. Cl. 713/163; 713/168

(57) ABSTRACT

An apparatus and method of sharing content is provided. An apparatus for sharing content according to an aspect of the invention includes a search module which extracts specific information from encrypted content, and requests a host apparatus for an execution code, and a client DRM agent module which is installed with the execution code received from the host apparatus according to the request and outputs the encrypted content using the execution code.

### CROSS REFERENCE TO RELATED APPLICATION

This application claims priority from Korean Patent Application No. 10-2007-0078634 filed on Aug. 6, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to sharing Digital Rights Management (DRM) agents, and more particularly, to sharing DRM agents in which specific information is extracted from encrypted content, an execution code is requested, a corresponding DRM agent program is installed using the received execution code, and encrypted content is output by using client DRM agents.

2. Description of the Related Art

The development of the Internet and multimedia technologies have supported the process of distributing and acquiring digital content. However, if a method of protecting copyrights of digital content does not exist, the development of the Internet and multimedia technologies give rise to digital content being illegally distributed.

DRM is a technology in which content holders protect copyrights of copyrighters, and consumers are prevented from illegally using content. Therefore, DRM provides safe distribution and spread of content, content control according government policy, and the like. According to DRM, all individual persons can access encrypted digital content, but only individuals who have a corresponding license can decrypt and reproduce the encrypted digital content. Accordingly, when DRM is used, it is possible to effectively protect the digital content as compared to when DRM is not used.

Generally, DRM is used to protect digital content and manage a digital-content-usage rule and an accounting system. When using DRM technology, the digital content is protected through an encryption process, such that the digital content can be prevented from being illegally distributed or used over an entire process including creation, distribution, usage, and discard. Further, DRM enables qualified users having an encryption key to decrypt and use the encrypted content. Therefore, even if the content is illegally distributed, individual persons who do not have an encryption key cannot use the content. As a result, it is possible to securely protect the content.

FIG. 1 is a schematic diagram illustrating a method of sharing a DRM license according to the related art. Referring to FIG. 1, a first DRM server 40 issues a DRM license and DRM content, to which a technology of a first DRM (DRM 1) is applied, to a first client apparatus 10. A second DRM server 50 issues a DRM license and DRM content to which a technology of a second DRM (DRM 2) is applied to a second client apparatus 20. Accordingly, since the technology of DRM 1 and the technology of DRM 2 are not compatible with each other, a repeater 30 needs to be provided. If the repeater 30 is used, the second client apparatus 20 requests the first client apparatus 10 to share content. After receiving the request for sharing the content, the first client apparatus 10 transmits information for a first DRM license or DRM content to the repeater 30. The repeater 30 modifies the technology of DRM 2 such that the technology of DRM 2 is compatible with the technology of DRM 1, and enables the second client apparatus to use the content from the first client apparatus.

As described above, according to the related art, the following problems occur. First, since the repeater needs to modify DRM technologies such that DRM technologies are compatible with each other, the first client apparatus and the second client apparatus should be on-line with the repeater and DRM servers. Second, a third apparatus, a repeater, is required. Third, various services must be provided by mutual agreement between service providers of a first DRM server and a second DRM server.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method of sharing DRM agents in which a client apparatus, which is provided with a DRM service to which a technology of a first DRM is applied, shares DRM agents to which a technology of a second DRM is applied, in order to use content to which the technology of the second DRM is applied.

The present invention also provides an apparatus and method of sharing DRM agents in which a host apparatus, including DRM agents, is installed in a home network and DRM agents are shared even in an offline state between a client apparatus and DRM agents.

According to an aspect of the invention, there is provided a client apparatus for sharing DRM agents, the client apparatus including a search module extracting specific information from encrypted content and requesting a host apparatus for an execution code, and a client DRM agent module installed with the execution code received from the host apparatus according to the request and outputting the encrypted content using the execution code.

According to another aspect of the invention, there is provided a host apparatus for sharing DRM agents, the host apparatus including a host DRM agent module encrypting a client DRM agent program requested from a client apparatus and creating an execution code, and an installing module installing the execution code in the client apparatus.

According to another aspect of the invention, there is provided a method of sharing DRM agents, the method including encrypting a client DRM agent program requested from a client apparatus, creating an execution code, and installing the execution code in the client apparatus.

According to another aspect of the invention, there is provided a method of sharing DRM agents, the method including installing a client DRM agent program from an execution code that is received from a host apparatus, and outputting encrypted content using the client DRM agents.

### BRIEF DESCRIPTION OF THE DRAWINGS

The above and other aspects of the present invention will become apparent by describing in detail exemplary embodiments thereof with reference to the attached drawings in which:

FIG. 1 is a schematic diagram illustrating a method of sharing a DRM license according to the related art;

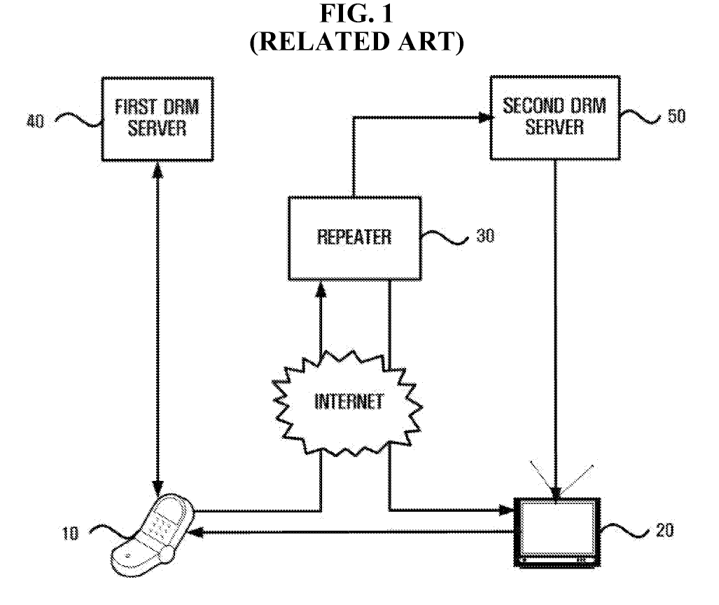

FIG. 2 is a schematic diagram illustrating a host apparatus and a client apparatus that are constituent elements of an apparatus for sharing DRM agents according to an exemplary embodiment of the invention;

FIG. 3 is a diagram illustrating a structure of a host DRM agent module of a host apparatus shown in FIG. 2;

FIG. 4 is a diagram illustrating a structure of a client DRM agent module of the client apparatus shown in FIG. 2; and

FIG. 5 is a flowchart illustrating a method of sharing DRM agents according to an exemplary embodiment of the invention.

### DETAILED DESCRIPTION OF THE EXEMPLARY EMBODIMENTS

Advantages and features of the invention and methods of accomplishing the same may be understood more readily by reference to the following detailed description of exemplary embodiments and the accompanying drawings. The invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the invention will only be defined by the appended claims. Like identification codes refer to like elements throughout the specification.

The present invention will be described hereinafter with reference to block diagrams or flowchart illustrations of an apparatus and method of sharing DRM agents according to exemplary embodiments thereof. It is to be understood that blocks in the accompanying block diagrams and compositions of steps in flow charts can be performed by computer program instructions. These computer program instructions can be loaded into processors of, for example, general-purpose computers, special-purpose computers, and programmable data processing apparatuses. Therefore, the instructions performed by the computer or the processors of the programmable data processing apparatus generate means for executing functions described in the blocks in block diagrams or the steps in the flow charts. The computer program instructions can be stored in a computer available memory or a computer readable memory of the computer or the programmable data processing apparatus in order to realize the functions in a specific manner. Therefore, the instructions stored in the computer available memory or the computer readable memory can manufacture products including the instruction means for performing the functions described in the blocks in the block diagrams or the steps in the flow charts. Further, the computer program instructions can be loaded onto the computer or the computer programmable data processing apparatus. Therefore, a series of operational steps is performed in the computer or the programmable data processing apparatus to generate a process executed by the computer, which makes it possible for the instructions driving the computer or the programmable data processing apparatus to provide steps of executing the functions described in the blocks of the block diagrams or the steps of the flow charts.

Each block or each step may indicate a portion of a module, a segment or a code including one or more executable instructions for performing a specific logical function (or functions). It should be noted that, in some modifications of the invention, the functions described in the blocks or the steps may be generated out of order. For example, two blocks or steps continuously shown can be actually performed at the same time, or they can sometimes be performed in reverse order according to the corresponding functions.

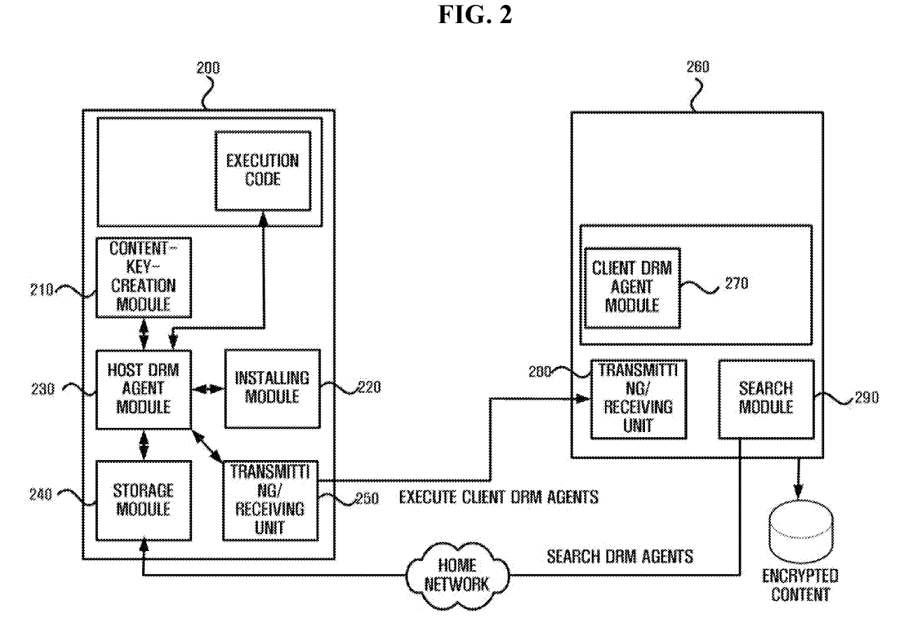

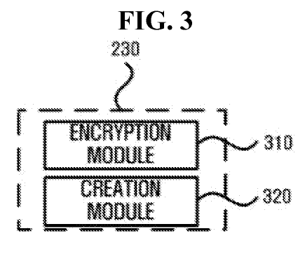

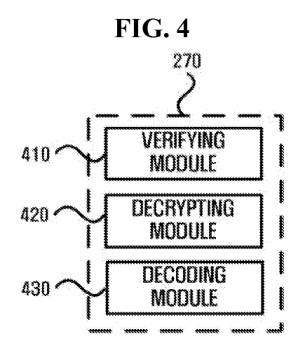

FIG. 2 is a schematic diagram illustrating a host apparatus and a client apparatus that are constituent elements of an apparatus for sharing DRM agents according to an exemplary embodiment of the invention. FIG. 3 is a diagram illustrating a structure of a host DRM agent module of the host apparatus shown in FIG. 2. FIG. 4 is a diagram illustrating a structure of a client DRM agent module of the client apparatus shown in FIG. 2.

Referring to FIGS. 2 and 4, a host apparatus 200 includes a content-key-creation module 210, an installing module 220, a host DRM agent module 230, a storage module 240, and a transmitting/receiving unit 250. Further, a client apparatus 260 includes a client DRM agent module 270, a transmitting/receiving unit 280, and a search module 290.

First, the client apparatus 260 will be described. The client apparatus 260 reproduces, copies, and moves content, and may be, but is not limited to, a media player, such as an MP3 player.

The search module 290 that is included in the client apparatus 260 searches DRM agents corresponding to encrypted content stored in the search module 290 to reproduce the encrypted content. At this time, according to an exemplary embodiment of searching the corresponding DRM agents, specific information is extracted from the encrypted DRM content, and a request for DRM services including the specific information is distributed to a home network by a multicasting method. This exemplary embodiment can be stored in the client apparatus 260 or implemented by using a universal plug and play (UPnP) function or the like. In this exemplary embodiment, the specific information includes content discrimination information, content information, content characteristic information, and the like that are relevant to the content.

The client DRM agent module 270 includes a verifying module 410, a decrypting module 420, and a decoding module 430.

The verifying module 410 verifies the modulation integrity of a client DRM program that is installed in the client apparatus 260. Further, the verifying module 410 verifies that a license in the client apparatus 260 has an access authority for encrypted content. Accordingly, a user can use the encrypted content in a content usage range that is defined in the license.

The decrypting module 420 decrypts the encrypted content using a content key that is received from the host apparatus 200. Accordingly, the decrypting module 420 decrypts the encrypted content in the client apparatus 260, and transmits the decrypted content to the decoding module 430.

After receiving the decrypted content, the decoding module 430 decodes the content and outputs it. In this exemplary embodiment, the output of the content includes reproduction, movement, and/or copying of the content.

The transmitting/receiving unit 280 requests DRM services from the host apparatus 200 that has DRM agents searched by the search module 290, or transmits a license to the host apparatus 200. The transmitting/receiving unit 280 receives an encrypted execution code including a client DRM agent program.

Further, the client apparatus 260 may include an installing module (not shown) that executes the execution code received from the host apparatus 200, and installs the client DRM agent program.

The host apparatus 200 will now be described. The host apparatus 200 may include a server that holds the DRM agent program, and is included in the home network.

As described above, when the client apparatus 260 requests the corresponding DRM services, the storage module 240 searches DRM agent programs that are stored in the storage module 240, and searches the corresponding DRM agent program. The storage module 240 transmits the corresponding DRM agent program to the host DRM agent module 230 to create an execution code.

The content-key-creation module 210 receives the license from the client apparatus 260 and creates a content key corresponding to the license. The created content key is transmitted to the client apparatus 260 through the transmitting/receiving unit 250. The client apparatus 260 decrypts the encrypted content using the content key, and decodes and outputs the decrypted content.

The host DRM agent module 230 includes an encryption module 310 and a creation module 320. When the client apparatus 260 requests DRM services, the encryption module 310 receives the corresponding client DRM program from the storage module 240 and encrypts the client DRM program by a code obfuscation method using a Content Encryption Key (CEK). The creation module 320 creates the execution code that includes the encrypted client DRM program. In this exemplary embodiment, the execution code can be created in a virtual machine that is included in the host apparatus 200.

The installing module 220 executes the installing code that is created by the host DRM agent module 230, and installs the client DRM program in the client apparatus 260. Further, the client DRM agent program that is included in the execution code may be installed in the virtual machine in the client apparatus 260.

The transmitting/receiving unit 250 requests DRM services to the host apparatus 200 that holds DRM agent program searched by the search module 290, and receives the license. The transmitting/receiving unit 250 transmits the execution code including the client DRM agents or the like to the client apparatus 260.

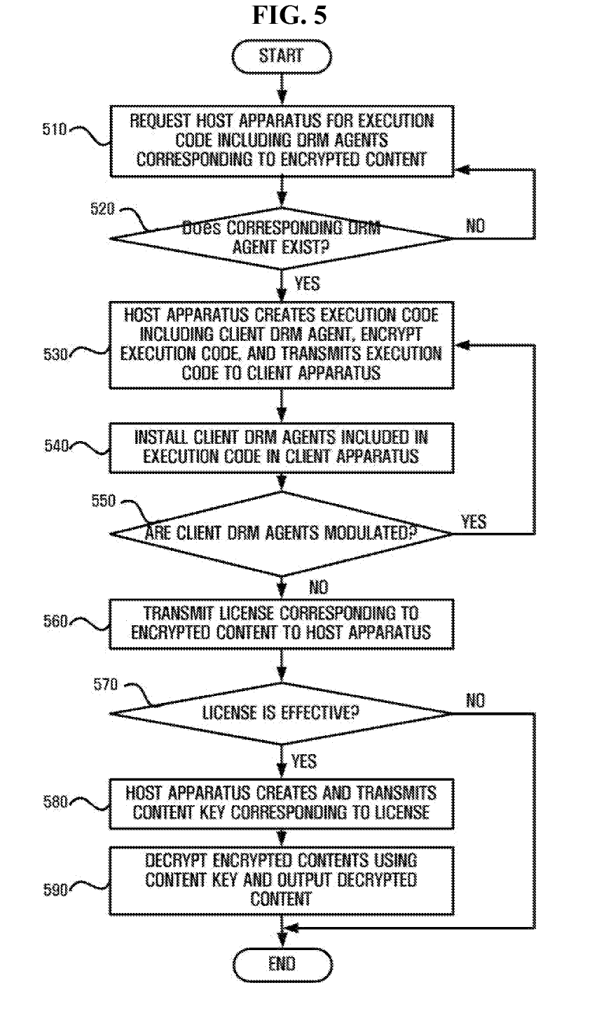

FIG. 5 is a flowchart illustrating a method of sharing DRM agents according to an exemplary embodiment of the present invention.

Referring to FIG. 5, the client apparatus 260 holds encrypted content to which a technology of DRM A is applied, but does not support the technology of DRM A. In this state, the client apparatus 260 requests the host apparatus 200 of the execution code including DRM agents corresponding to the encrypted content (S510). In this exemplary embodiment, the request for the execution code includes that the client apparatus 260 searches the corresponding DRM agents. Accordingly, in the method of searching the corresponding DRM agents, the specific information is extracted from the encrypted DRM content and the request for DRM services including the specific information is distributed to the home network by a multicasting method. This searching method may be stored in the client apparatus 260 or implemented by using an UPnP function or the like. In this exemplary embodiment, the host apparatus 200 is included in the home network, and includes a server that includes formats of a plurality of DRM technologies. The client apparatus 260 includes, but is not limited to, media players, such as an MP3 player, which reproduce content.

After the client apparatus 260 searches the corresponding DRM agents and accesses the host apparatus 200, the host apparatus 200 confirms whether the corresponding DRM agents exist (S520).

If the corresponding DRM agents do not exist, the host apparatus 200 informs the client apparatus 260 of the fact that the corresponding DRM agents do not exist. The client apparatus 260 searches the corresponding DRM agents again, and requests the host apparatus 200 for the corresponding agents (S510).

If the corresponding DRM agents exist, the host apparatus 200 informs the client apparatus 260 of information for the corresponding DRM services and a message indicating that the corresponding DRM agents exist. The client apparatus 260 receives the message indicating that the corresponding DRM agents exist from the host apparatus 200. Then, when the client apparatus 260 requests the corresponding DRM services, the host apparatus 200 creates the execution code that includes the client DRM agents and encrypts the execution code, and transmits the execution code to the client apparatus 260 (S530). The host apparatus 200 that is called upon to transmit the corresponding DRM services creates the corresponding client DRM agents, and transmits the execution code, which is created by encrypting the created DRM agents by a code-obfuscation method using a CEK, to the client apparatus 260. In this exemplary embodiment, the execution code that includes the client DRM agents may be created in the virtual machine in the host apparatus 200.

The client DRM agents that are included in the execution code are installed in the client apparatus 260 (S540). The host apparatus 200 or the client apparatus 260 may install the client DRM agents. The host apparatus 200 may transmit the client DRM agents and automatically install the client DRM agents in the client apparatus 260. Alternatively, the user may directly execute the received client DRM agents and install the client DRM agents.

The client DRM agents, installed in the client apparatus 260, are checked to determine whether they are modulated (S550). At least one of the host apparatus 200 and the client apparatus 260 may check whether the client DRM agents are modulated. When the installed client DRM agents are modulated, processes that correspond to operations 530 and 540 are repeatedly performed.

When the installed client DRM agents are not modulated, the license that corresponds to the encrypted content is transmitted to the host apparatus 200 (S560).

The host apparatus 200 that receives the license checks whether the license is effective (S570). In this case, the client apparatus 260 can confirm whether the license is effective before transmitting the license. In a method of confirming whether the license is effective, it is confirmed whether the installed client DRM agents have an access authority on the encrypted content using the license. When the installed client DRM agents have the access authority, the license is transmitted to the host apparatus 200. When the installed client DRM agents do not have the access authority, the process is completed. In this case, the access authority means the number of reproduction times, whether a copying process is allowed, and the like.

The host apparatus 200 that receives the license from the client apparatus 260 creates a content key corresponding to the license and transmits the content key (S580). The host apparatus 200 creates and encrypts the content key, and transmits the encrypted content key to the client apparatus 260. The client apparatus 260 that receives the content key stores the content key.

The content that is encrypted using the content key are decrypted, and the encrypted content is output (S590), which completes the process.

According to the apparatus and method of sharing DRM agents according to the exemplary embodiments of the invention, the apparatus that is connected to the home network can share DRM agents for offline use and share the content.

Further, it is not necessary to provide the repeater that corresponds to the third apparatus.

Furthermore, since DRM agents are shared and provided, it is possible to provide content-sharing services without mutual agreement between the content providers.

Although the invention has been described in connection with the exemplary embodiments of the invention, it will be apparent to those skilled in the art that various modifications and changes may be made thereto without departing from the scope and spirit of the invention. Therefore, it should be understood that the above embodiments are not limitative, but illustrative in all aspects.

What is claimed is:

1. A client apparatus for sharing Digital Rights Management (DRM) agents, the client apparatus comprising:
a search module which extracts specific information from encrypted content and requests an execution code from a host apparatus; and
a client DRM agent module which is installed with the execution code received from the host apparatus according to the request and outputs the encrypted content using the execution code.

2. The client apparatus of claim 1, wherein the specific information comprises at least one of content discrimination information, content information, and content characteristic information that are relevant to the content.

3. The client apparatus of claim 1, wherein the client DRM agent module comprises a verifying module which verifies a modulation integrity of a client DRM agent program.

4. The client apparatus of claim 3, wherein the verifying module verifies that a license has an access authority for the encrypted content, and transmits the license to the host apparatus.

5. The client apparatus of claim 1, wherein the client DRM agent module includes a decrypting module which decrypts the encrypted content using a content key received from the host apparatus.

6. The client apparatus of claim 1, wherein the execution code includes a client DRM agent program.

7. A host apparatus for sharing Digital Rights Management (DRM) agents, the host comprising:
a host DRM agent module which encrypts a client DRM agent program requested from a client apparatus and creates an execution code; and
an installing module which installs the execution code in the client apparatus.

8. The host apparatus of claim 7, further comprising:
a storage module in which at least one DRM agent program is stored.

9. The host apparatus of claim 8, wherein the storage module searches the client DRM agent program.

10. The host apparatus of claim 8, wherein the host DRM agent module comprises an encryption module which loads the client DRM agent program from the storage module, and encrypts the client DRM agent program.

11. The host apparatus of claim 10, further comprising:
a creation module which creates the encrypted client DRM agent program as the execution code.

12. The host apparatus of claim 7, further comprising:
a content-key-creation module creating a content key corresponding to a license that is received from the client apparatus.

13. A method of sharing Digital Rights Management (DRM) agents, the method comprising:
installing a client DRM agent program from an execution code that is received from a host apparatus; and
outputting encrypted content using the client DRM agents.

14. The method of claim 13, further comprising:
searching the client DRM agents corresponding to the encrypted content.

15. The method of claim 14, wherein the searching the client DRM agents is extracting specific information for the encrypted content, and multicasting the specific information to search the client DRM agents.

16. The method of claim 15, wherein the specific information comprises at least one of content discrimination information, content information, and content characteristic information that are relevant to the content.

17. The method of claim 13, further comprising:
verifying modulation integrity of the client DRM agent program after the installing the client DRM agent program.

18. The method of claim 13, wherein the outputting the encrypted content comprises:
verifying that a license has an access authority for the encrypted content; and
transmitting the license.

19. The method of claim 13, wherein the outputting the encrypted content comprises:
receiving a content key corresponding to a license; and
decrypting the encrypted content using the content key.

20. The method of claim 13, wherein the outputting comprises at least one of reproduction, copying, and movement.

21. A method of sharing Digital Rights Management (DRM) agents, the method comprising:
encrypting a client DRM agent program requested from a client apparatus and creating an execution code; and
installing the execution code in the client apparatus.

22. The method of claim 21, further comprising:
receiving a license corresponding to encrypted content; and
creating a content key corresponding to the encrypted content using the license, and transmitting the created content key.

23. The method of claim 21, further comprising:
verifying the client DRM agent program after the installing the execution code.

24. The method of claim 21, further comprising:
searching the client DRM agent program corresponding to specific information that is extracted from encrypted content.
